(19) United States
(12) Patent Application Publication
(10) Pub. No.: US 2012/0228058 A1
(43) Pub. Date: Sep. 13, 2012

(54) Step Guard

(76) Inventor: JoAnn Dubois, Lynn, MA (US)

(21) Appl. No.: 13/411,819

(22) Filed: Mar. 5, 2012

Related U.S. Application Data
(60) Provisional application No. 61/450,192, filed on Mar. 8, 2011.

(51) Int. Cl. E06C 7/00

(52) U.S. Cl. 182/129

(57) ABSTRACT

A step guard device that enables a user to prevent a small or unsupervised child from ascending a ladder such as the type commonly used with swing sets, tree house, and the like by preventing the small child from accessing one or more rungs or steps of the ladder. The step guard device is preferably comprised of a barricade and an attachment device for removably attaching said device to the ladder. The device can also be positioned along the ladder so as to permit bigger children and/or adults to safely traverse the device and use the ladder to enjoy the structure to which it is attached.

### CROSS-REFERENCE

This application claims priority from Provisional Patent Application Ser. No. 61/450,192 filed on Mar. 8, 2011.

### FIELD OF THE INVENTION

This invention relates to a device for preventing unauthorized use of a ladder and, more particularly, a ladder for use with a swing set, tree house, or other structure commonly used by children.

### BACKGROUND

Ladders are well known in the art for accessing structures or platforms at higher elevations. For instance, swing sets and tree houses often have accompanying ladders that allow children to access an elevated platform for purposes of, for example, sliding down a sliding board. Nonetheless, these types of ladders can also be dangerous, and are not necessarily suitable for younger or unsupervised children. For example, a younger or unsupervised child attempting to access the structure to which the ladder is attached may fall from the ladder or the structure, or could slip between the rungs of the ladder, which could lead to serious injury or even death of the child.

One way known in the art to prevent these types of injuries is to limit access to the ladder by covering one or more of the ladder rungs with a board or the like. However, these types of devices typically deny everyone access to the ladder, not just young or unsupervised children, which limits the ability of older children or adults to enjoy the swing set, tree house or the like. Other devices exist for preventing the unauthorized access of a ladder or other climbing instrument, but are often times complicated and time consuming to install, operate and remove and can be expensive.

Consequently, there exists in the art a long-felt need for an improved step guard device that prohibits unauthorized access to the rungs or steps of a ladder by a young and/or unsupervised child, while permitting access to the same by an older child or an adult. Additionally, there is a long-felt need for a step guard device that is relatively easy to install, use and remove, and that is relatively easy and inexpensive to manufacture and use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a step guard device for removably attachment to a rung or step of a ladder or other structure used for climbing. In one embodiment of the present invention, the step guard device comprises a barricade and at least one attachment device for removably attaching said barricade to a ladder rung or step. In a preferred embodiment of the present invention, the step guard device prevents unauthorized access to two or more steps or rungs of a ladder, and the top of the barricade is substantially even with the next rung on the ladder, thereby allowing an older child to step onto the top of said barricade and rung and safely traverse the barricade. In a still further preferred embodiment of the present invention, the barricade is at least as wide as the overall width of the ladder for which it is being used.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a prior art ladder of the type that the present invention could be used in conjunction with.

FIG. 2 illustrates a perspective view of the front and side of the step guard device of the present invention.

FIG. 3 illustrates a perspective view of the rear and side of the step guard depicted in FIG. 2.

FIG. 4 illustrates a front perspective view of a preferred embodiment of the step guard device of the present invention installed on a prior art ladder.

FIG. 5 illustrates a back perspective view of the step guard device of FIG. 4 installed on a prior art ladder.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

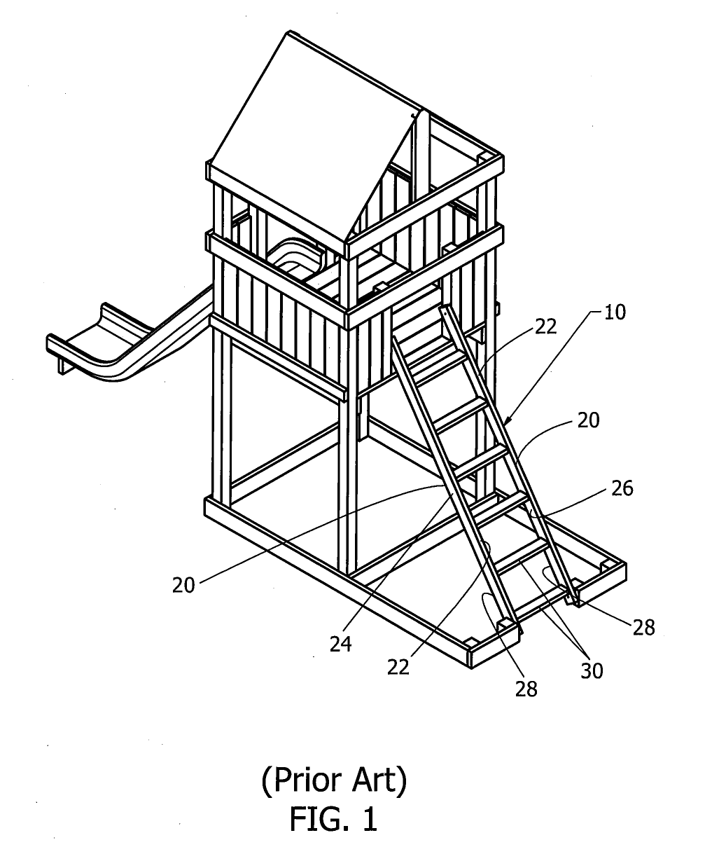

Referring initially to the drawings, FIG. 1 illustrates a perspective view of a prior art ladder 10 of the type that the present invention could be used in conjunction with. As with most climbing devices, ladder 10 is comprised of two elongated, generally parallel and spaced apart rails 20 that are connected to one another by a plurality of generally parallel and spaced apart rungs or steps 30, as best illustrated in FIG. 1. Each of rails 20 further comprise a top surface 22, outboard surface 24, inboard surface 26 and bottom surface 28. Inasmuch as prior art ladder 10 is typically setup in a somewhat inclined positioned, bottom surface 28 of rail 20 faces in the general direction of the ground or surface upon which ladder 10 rests, and top surface 22 generally faces upward, or in the direction of the user (not shown). Similarly, inboard surfaces 26 of said rails 20 face inward towards one another, whereas outboard surfaces 24 face outwardly, and away from each other as shown in FIG. 1.

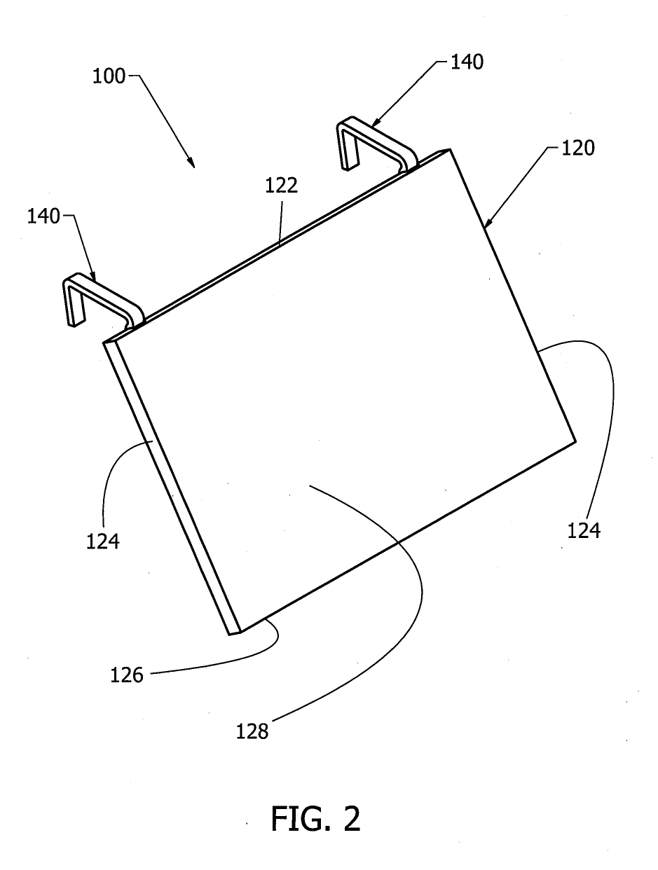

FIG. 2 illustrates one embodiment of the step guard device 100 of the present invention, which is preferably comprised of a barricade 120 and at least one, and preferably two, attachment device(s) 140. Barricade 120 can be a board or other generally flat or planar surface that can be used to deny access to steps 30 when device 100 is properly installed on ladder 10, as illustrated in the accompanying FIGS. and described further below. Barricade 120 is preferably comprised of a top 122, sides 124, bottom 126, an outboard face 128 and an inboard face 129. When properly installed on a ladder 10, outboard face 128 faces away from ladder 10, whereas inboard face 129 faces ladder 10 and may be in contact with at least a portion of the outboard surface 24 of rails 20.

In a preferred embodiment, barricade 120 is generally rectangular in shape, and comprised of at least one of the following: wood, plastic, composite material or metal. Nonetheless, it is also contemplated that barricade 120 can be comprised of other shapes and durable materials without affecting the overall concept of the present invention.

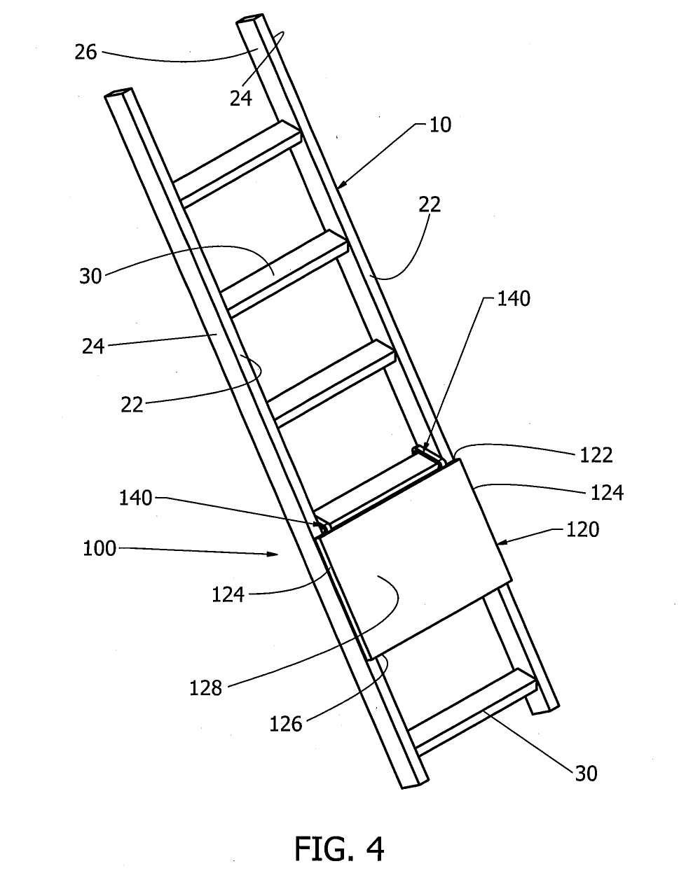

Barricade 120 is preferably wide enough, as measured from one side 124 to the other side 124, to span the entire width of ladder 10, as measured from the outboard surface 24 of one rail 20 to the outboard surface 24 of the other rail 20. Nonetheless, it is also contemplated that barricade 120 could be wide enough to span steps 30, and to cover at least a portion of the top surface 22 of each of rails 20, as best shown in FIG. 4, which provides additional support for device 100. Inasmuch as most prior art ladders 10 are between 10 and 30 inches wide, as measured from the outboard surface 24 of one rail 20 to the outboard surface 24 of the other rail 20, it is contemplated that barricade 120 should also be between 10 and 30 inches in width.

In a preferred embodiment, barricade 120 is long enough, as measured from the top 122 to the bottom 126, to span or cover at least two rungs or steps 30, thereby preventing a young or unsupervised child (not shown) from successfully ascending ladder 10, but still permitting an older child or adult (also not shown) to enjoy the use of the ladder by stepping over barricade 120. More specifically, when device 100 is properly installed, a child (not shown) with short legs will not be able to step over barricade 120, nor will the child be able to access the steps 30 that are covered by barricade 120. Moreover, outboard face 128 of barricade 120 is preferably a relatively smooth surface, thereby preventing the child from obtaining the necessary traction to successfully traverse or climb on the outboard surface 128 of barricade 120.

Inasmuch as the rungs or steps 30 of most prior art ladders 10 are spaced apart by between 10 and 16 inches, it is contemplated that barricade 120 should be between 20 and 32 inches in length, as measured from the top 122 to the bottom 126. Nonetheless, it is also contemplated that barricade 120 can be manufactured to shorter or greater lengths to satisfy user preference.

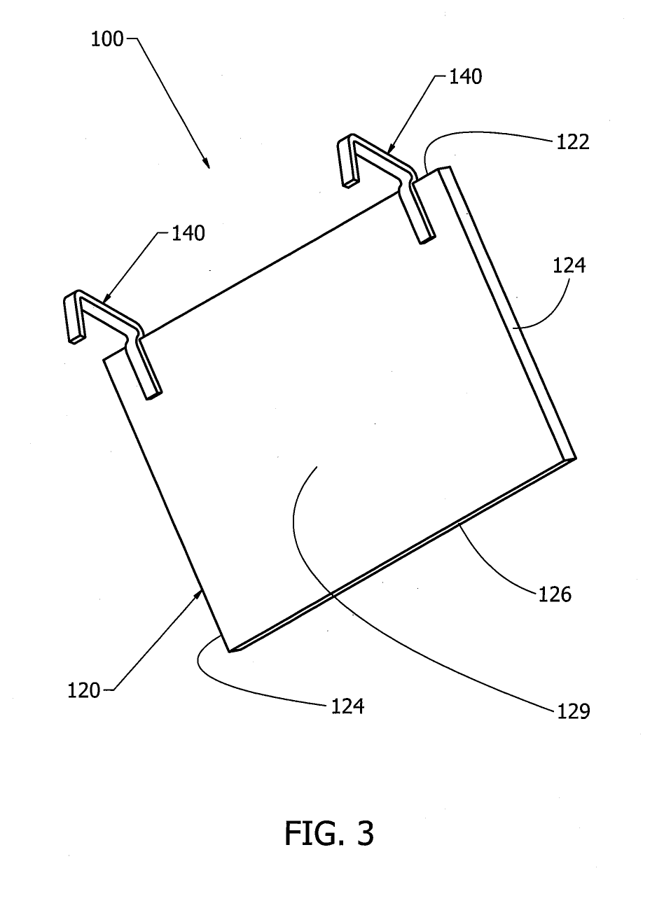

Attachment device 140 functions to removably attach barricade 120 to prior art ladder 10. Attachment device 140 is preferably comprised of at least one clamp or hook that can be attached to the inboard face 129 of barricade 120, as best illustrated in FIG. 3, for subsequent removable attachment or engagement with rung or step 30 as described below. Nonetheless, it is also contemplated that attachment device 140 could be other types of devices such as a grapple, clamp, or the like, without affecting the overall concept of the present invention, provided that the same does not impede a user's ability to climb over barricade 120. Attachment device or hook 140 can be comprised of metal, plastic, wood, or any other suitable material for attaching barricade 120 to ladder 10. Attachment device or hook 140 can be attached to barricade 120 by any common means known in the art such as nails, screws, fasteners, glue and the like.

In a preferred embodiment, hook 140 is positioned along inboard face 129 of barricade 120 so that when device 100 is properly installed on prior art ladder 10, the top 122 of barricade 120 is substantially the same height, as measured from the ground, as a rung or step 30 on ladder 10. By making the top 122 of barricade 120 substantially the same height as a step 30 on ladder 10, an older child or adult (not shown) will be able to step on top portion 122 of barricade 120 and step 30, and safely traverse step guard device 100. However, smaller children (not shown) will be unable to access ladder 10 due to the presence of step guard device 100, which blocks the child's access to the lower steps 30.

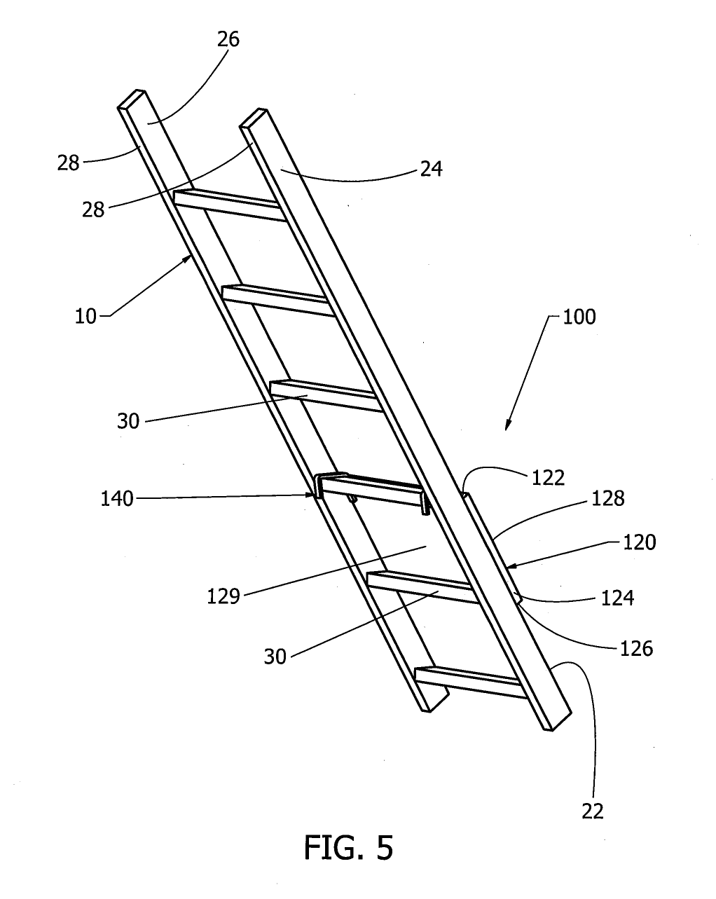

In a more preferred embodiment, hook 140 is also positioned along inboard face 129 of barricade 120 so that it is immediately adjacent to or in contact with inboard surface 26 of rail 20 and a second hook 140 is positioned along inboard face 129 of barricade 120 so that the second hook 140 is immediately adjacent to or in contact with the inboard surface 26 of the other rail 20, as best illustrated in FIG. 5. The placement of hooks 140 in this manner prevents the lateral movement of device 100 relative to ladder 10, thereby increasing the overall stability and effectiveness of device 100 as will be appreciated by one of ordinary skill in the art. Importantly, attachment device or hooks 140 can be repositioned along inboard face 129 of barricade 120 to accommodate different sized ladders 10.

Having now described the preferred embodiment of the step guard device 100, its use and usefulness will now be described. A user (not shown) desiring to prevent a young or unsupervised child from accessing a ladder 10 can removably attach step guard device 100 to a desired run or step 30 on ladder 10 thereby denying the child access to the lower steps 30 which are necessary for the child to ascend ladder 10. To attach said device 100 to ladder 10, the user simply places the hook or attachment device 140 around or over the rung or step 30 and the weight of device 100 causes the device to hang down from step 30 over a portion of the top surface 22 of rails 20 and at least two steps 30, thereby denying a small child access to the ladder 10. Further, assuming that the attachment device or hooks 140 are properly attached to barricade 120 in the manner described above, the lateral movement of device 100 will be impeded, thereby improving the overall stability of device 100, and a larger or older child will be able to safely traverse device 100 by simultaneously stepping on top portion 122 of barricade 120 and step 30.

When the user desires to again permit access to ladder 10, he or she can simply lift the step guard device 100 of the present invention in an upward direction (i.e., away from the ground) to unhook the attachment device 140 from rung or step 30. The relatively flat nature of step guard device 100 allows it to be easily stored until its next use.

It will be appreciated by those of ordinary skill in the art that device 100 can be comprised of lightweight and/or weatherproofed materials so that it can be enjoyed year round, regardless of climate. The device 100 of the present invention is easy to install/uninstall on a prior art ladder, and is relatively inexpensive to manufacture.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A step guard device comprising:
a barricade with a top portion; and
at least one attachment device for removably attaching said barricade to a ladder with a plurality of steps wherein said top portion is substantially the same height as at least one of said plurality of steps.

2. The step guard device of claim 1 wherein said barricade prevents unauthorized access to at least two of said plurality of steps.

3. The step guard device of claim 1 wherein said barricade is comprised of at least one of the following: wood, plastic, composite material or metal.

4. The step guard device of claim 1 wherein said at least one attachment device is a hook that is attached to said barricade, and removably attached to at least one of said plurality of steps.

5. The step guard device of claim 1 wherein said at least one attachment device is comprised of metal.

6. The step guard device of claim 1 wherein said ladder further comprises at least one rail having an inboard surface, wherein said at least one attachment device is in contact with at least a portion of said inboard surface.

7. The step guard device of claim 1 comprised of two attachment devices.

8. A step guard device comprising:
a barricade with a top portion; and
at least one attachment device for removably attaching said barricade to a ladder with a plurality of steps wherein said top portion is substantially the same height as at least one of said plurality of steps and wherein said barricade extends over at least a portion of a pair of rails of said ladder.

9. The step guard device of claim 8 wherein said barricade prevents unauthorized access to at least two of said plurality of steps.

10. The step guard device of claim 8 wherein said barricade is comprised of at least one of the following: wood, plastic, composite material or metal.

11. The step guard device of claim 8 wherein said at least one attachment device is a hook that is attached to said barricade, and removably attached to at least one of said plurality of steps.

12. The step guard device of claim 8 wherein said at least one attachment device is comprised of metal.

13. The step guard device of claim 8 wherein each of said pair of rails further comprises an inboard surface, wherein said at least one attachment device is in contact with said inboard surface.

14. The step guard device of claim 8 comprised of two attachment devices.

15. A step guard device for removable attachment to a ladder comprising:
a barricade with a top portion and a width, wherein said width is as least as wide as said ladder; and
at least one attachment device for removably attaching said barricade to a ladder with a plurality of steps wherein said top portion is substantially the same height as at least one of said plurality of steps.

16. The step guard device of claim 15 wherein said barricade prevents unauthorized access to at least two of said plurality of steps.

17. The step guard device of claim 15 wherein said barricade is comprised of at least one of the following: wood, plastic, composite material or metal.

18. The step guard device of claim 15 wherein said at least one attachment device is a hook that is attached to said barricade, and removably attached to at least one of said plurality of steps.

19. The step guard device of claim 15 wherein said at least one attachment device is comprised of metal.

20. The step guard device of claim 15 wherein said ladder further comprises at least one rail having an inboard surface, wherein said at least one attachment device is in contact with at least a portion of said inboard surface.
